(19) United States
(12) Patent Application Publication
(10) Pub. No.: US 2009/0109240 A1
(43) Pub. Date: Apr. 30, 2009

(54) Method and System for Providing and Reconstructing a Photorealistic Three-Dimensional Environment

(76) Inventors: Roman Englert, Even Yehuda (IL); Yuval Elovici, Arugot (IL); Martin Kurze, Berlin (DE); Katja Henke, Berlin (DE)

Correspondence Address: KEVIN D. MCCARTHY;ROACH BROWN MCCARTHY & GRUBER, P.C., 424 MAIN STREET, 1920 LIBERTY BUILDING, BUFFALO, NY, 14202, US

(21) Appl. No.: 11/877,736

(22) Filed: Oct. 24, 2007

(51) Int. Cl. G09G 5/00

(52) U.S. Cl. 345/633

(57) ABSTRACT

The present invention relates to a method and system for providing and reconstructing a photorealistic environment, by integrating a virtual item into it, comprising: (a) a dedicated marker, placed in a predefined location within an environment, in which a virtual item has to be integrated, for enabling determining the desired location of said virtual item within said environment; (b) a conventional camera for taking a picture or shooting a video clip of said environment, in which said marker was placed, and then providing a corresponding images of said environment; and (c) one or more servers for receiving said corresponding image of said environment from said camera, processing it, and outputting a photorealistic image that contains said virtual item integrated within it, comprising: (c.1.) a composer for composing a photorealistic image from said corresponding image of said environment; (c.2.) an image processing unit for processing said corresponding image and for determining the location of said marker within said environment; (c.3.) a configuration database for storing configurations and other data; and (c.4.) an image rendering unit for reconstructing the photorealistic image by integrating said virtual item into said predefined location of the photographed environment, wherein said marker is located.

### FIELD OF THE INVENTION

The present invention relates to photo-realistic object rendering. More particularly, the invention relates to a method and system for providing and reconstructing a photorealistic 3-D (three-dimensional) user environment, in which one or more artificial objects are relatively seamlessly integrated and presented to a viewer.

### BACKGROUND OF THE INVENTION

Mixed reality (MR) is a topic of much research and has found its way into a number of applications, most evident in the arts and entertainment industries. The mixed reality is the merging of real world and virtual worlds to produce new environments where physical and digital objects can co-exist and interact in real-time. The mixed reality is actually a mix of augmented reality, augmented virtuality and virtual reality, combining a variety of 3-D modeling, tracking, haptic feedback, computer human interface, simulation, rendering and display techniques; the mixed reality can be a complex process at the very cutting edge of today technology.

It is supposed, for example, that a person shops in an online store, such as Amazon.com® or eBay®. He finds an item (e.g. a piece of furniture, a new TV-set or an artwork), which seems to be of interest to him. The first thing said person will do, will be to gather in-depth information about the item, e.g. by reading the technical specification or by viewing some photos. But reading this information and watching the pictures will only be a first step towards the purchasing decision. In many cases, people want more: they want to know how the desired item (object) will look in the intended environment, e.g. in a living room.

A lot of work today concentrates in the area of mobile devices, trying to utilize the 3-D power of the mobile device to obtain the best results possible. Mobile phones (and other mobile devices such as PDAs (Personal Digital Assistants) are today relatively powerful machines in terms of calculation power and memory. In some aspects, the mobile devices can be compared with 10 year old PCs. However, they lack the PC-capabilities in at least one important aspect, such as graphics acceleration and display resolution (and size). Recently, it has become easier to program these devices, since there are now some standard application environments available, including operating systems (e.g., Symbian® or Microsoft Windows® for Mobiles), as well as 3-D presentation engines, such as Direct-X® or OpenGL. In addition, run-time environments, such as Java®, are now available in versions that support 3-D real-time to a certain extent. While the prior art approaches offer advantages for certain types of mobile applications, they are rather far away from the high-quality mixed reality. In addition, they do not try to reach photorealistic quality in their visual rendering output. This is due to the fact that the real-time interaction and large data volumes (as found in 3-D city maps) are more in the focus of the prior art.

Mixed reality systems are not new in today's research labs. The general approach is in most cases, structured like this: a camera captures live-images/video from the environment (scenario); then, the video stream is processed (in near-real-time) to identify known objects and respective positions in relation to the camera. It is assumed that the camera shows, more or less the exact users' perspective. This can be achieved by mounting the camera on the user's head, possibly on a helmet or head-strap (or even special goggles). The computer performs the necessary image analysis to recognize certain objects. In the second phase of the procedure, some additional information is presented to the viewer, while he still looks at the scene. This additional information can be either textual (e.g., some known attributes of recognized objects, such as names) or graphical (e.g., line-drawings of internal parts of an object, which are not visible from the outside, such as the position of the cartridge within a laser printer). Probably, the most challenging type of such additional information is the rendered 3-D graphics (e.g., a planned building rendered into an outdoor scene of the intended construction site). Further, a few attempts have been made to port augmented reality (AR) to mobile devices. However, all prior art technologies and solutions refer to scientific or business scenarios and require powerful computers, high-end cameras and a detailed knowledge of the 3-D features of the intended environment. Also, the mixed reality technology concentrates on conveying the most relevant aspects of the additional (virtual) information/object, which leads to the graphically limited results (text, line-drawings, or simple 3-D objects).

On the other hand, the photorealistic mixed reality is used more and more in movies. For example, in 1993, the “Jurassic Park” movie was the first major movie making extensive use of photorealistically rendered objects (dinosaurs) into conventionally filmed scenes. However, the movie-quality rendering (in particular, if it involves mingling photos and virtual objects) requires expensive machines and software, and takes a relatively long time. “Near-real-time” requirements, as they are common in the mixed reality, are still far out of reach for this technology, and thus for the photorealistic quality. Finally, mixed reality has not reached the mass market. The technology is just beginning to gain relevance in only very limited areas. As such, in the games area, Sony® PlayStations® with eye-toys give a hint of how MR can be successful: this console recognizes players' hands with the attached camera and lets the user interact with virtual objects, such as balls, in real-time. Currently, there are a number of research approaches to make MR available for the mass market. However, as indicated above, the prior art applications have many limitations (e.g., their graphical quality is relatively poor, especially of those related to photorealistic environment).

U.S. Pat. No. 6,760,026 discloses a system and process for rendering a virtual reality environment having an image-based background, which allows a viewer to move about and interact with 3-D graphic objects in a virtual interaction space of the environment. This is generally accomplished by first rendering an image-based background, and separately rendering geometry-based foreground objects. However, U.S. Pat. No. 6,760,026 does not teach a method and system for providing and reconstructing the photorealistic 3-D user environment by employing a dedicated marker for determining the spatial and optical conditions of the scene, and enabling simulating the “real” (current) lightning and shadow conditions.

Therefore, there is a continuous need to overcome the above prior art drawbacks.

It is an object of the present invention to provide a method and system for providing photorealistic 3-D user environment, in which one or more artificial (virtual) objects are relatively seamlessly integrated and presented to a viewer.

It is another object of the present invention to present a method and system for providing photorealistic 3-D pictures, rendering the objects according to the lighting (optical) and according to other conditions of the “real” environment, at the time of taking the picture/video.

It is still another object of the present invention to present a method and system, in which is determined which color and/or intensity of the light, within the photographed environment, comes from which direction.

It is still another object of the present invention to present a method and system, in which the main processing is performed at the server side, enabling users to use relatively lightweight and relatively cheap photographic devices (e.g., mobile phones that have relatively low processing resources, thus saving their battery power).

It is a further object of the present invention to provide a method and system, which can be used in a plurality of applications, such as shopping-support applications, architectural simulation applications, entertainment applications, and many others.

It is still a further object of the present invention to provide a method and system, in which the photorealistic mixed reality images are provided in a relatively high visual quality.

It is still a further object of the present invention to provide a photorealistic method and system, which can be used for the industry and mass market at the same time.

It is still a further object of the present invention to provide a method and system, which is relatively inexpensive.

It is still a further object of the present invention to provide a method and system, which is user friendly.

Other objects and advantages of the invention will become apparent as the description proceeds.

### SUMMARY OF THE INVENTION

The system for providing and reconstructing a photorealistic environment, by integrating a virtual item into it, comprises:
a) a dedicated marker, placed in a predefined location within an environment, in which a virtual item has to be integrated, for enabling determining the desired location of said virtual item within said environment;
b) a conventional camera for taking a picture or shooting a video clip of said environment, in which said marker was placed, and then providing a corresponding images of said environment; and
c) one or more servers for receiving said corresponding image of said environment from said camera, processing it, and outputting a photorealistic image that contains said virtual item integrated within it, comprising:
   c.1. a composer for composing a photorealistic image from said corresponding image of said environment;
   c.2. an image processing unit for processing said corresponding image and for determining the location of said marker within said environment;
   c.3. a configuration database for storing configurations and other data; and
   c.4. an image rendering unit for reconstructing the photorealistic image by integrating said virtual item into said predefined location of the photographed environment, wherein said marker is located.

According to a preferred embodiment of the present invention, the marker enables the image processing unit to determine a spatial location of the virtual item to be integrated into the environment.

According to another preferred embodiment of the present invention, the marker enables determining lighting and corresponding shadow conditions of the photographed environment.

According to still another preferred embodiment of the present invention, the image rendering unit further simulates lighting and corresponding shadow conditions of the photographed environment.

According to a particular preferred embodiment of the present invention, the marker is composed of a black-and-white board.

According to another particular preferred embodiment of the present invention, the marker is composed of a board, having a predefined texture for enabling to determine a spatial orientation of said marker within the photographed environment.

According to a preferred embodiment of the present invention, the marker comprises a mirror reflecting sphere for determining the lighting and corresponding shadow conditions of the environment, in which it is located.

According to a particular preferred embodiment of the present invention, the mirror reflecting sphere of the marker is connected to said marker by means of a rod.

According to a preferred embodiment of the present invention, the image processing unit by means of the marker mirror reflecting sphere further determines which color and/or intensity of the light, within the photographed environment, comes from which direction.

According to another preferred embodiment of the present invention, the image processing unit is further used for estimating camera parameters.

According to still another preferred embodiment of the present invention, the camera parameters are selected from one or more of the following:
a) the focal distance of the lens of said camera;
b) the viewing direction and orientation of said camera; and
c) the position of said camera in a space.

According to a further preferred embodiment of the present invention, the system further comprises providing a model and material database for storing predefined models and materials to be integrated into the taken image of the environment, or storing links to said models and materials, if they are stored on another server.

According to still a further preferred embodiment of the present invention, the marker is displayed on a mobile device screen or provided in a printed form.

According to still a further preferred embodiment of the present invention, a user can select and configure the virtual item to be integrated into the photographed environment.

The method for providing and reconstructing a photorealistic environment, by integrating a virtual item into it, comprises:
a) placing a dedicated marker in a predefined location within an environment, in which a virtual item has to be integrated, for enabling determining the desired location of said virtual item within said environment;
b) taking a picture or shooting a video clip of said environment, in which said marker was placed, by means of a conventional camera; and
c) receiving said image of said environment with a maker from said camera by means of one or more servers, processing said image, and outputting a photorealistic image that contains said virtual item integrated within it, said one or more servers comprising:
   c.1. a composer for enabling a user to compose a photorealistic image from said corresponding image of said environment;
   c.2. an image processing unit for processing said corresponding image and for determining the location of said marker within said environment;
   c.3. a configuration database for storing users' configurations and other data; and
   c.4. an image rendering unit for reconstructing the photorealistic image by integrating said virtual item into said predefined location of said environment.

### BRIEF DESCRIPTION OF THE DRAWINGS

In the drawings:

FIG. 1 is a schematic illustration of a system for providing and reconstructing a photorealistic user environment, according to a preferred embodiment of the present invention;

FIGS. 2A and 2B are sample input and output images, respectively, according to a preferred embodiment of the present invention;

FIGS. 3A and 3B are illustrations of a dedicated marker and its mirror reflecting sphere, respectively, according to another preferred embodiment of the present invention; and

FIGS. 4A and 4B are sample input and output images respectively, according to another preferred embodiment of the present invention.

### DETAILED DESCRIPTION OF THE PREFERRED EMBODIMENTS

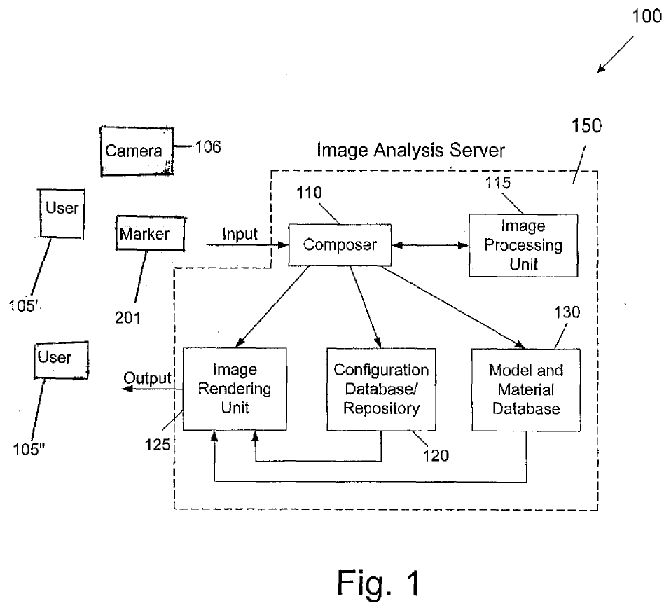

FIG. 1 is a schematic illustration of a system 100 for providing and reconstructing a photorealistic user environment, according to a preferred embodiment of the present invention. System 100 comprises: a camera 106 for taking a picture (or shooting a movie/video clip) of the environment, and providing a conventional image (or video clip) of said environment in a conventional file format, such as JPEG (Joint Photographic Experts Group), etc.; a dedicated marker 201, placed in a predefined location within said environment in which a virtual item has to be integrated, for enabling determining the desired spatial orientation of an (virtual) item to be integrated into said environment, and enabling determining the “real” lighting (optical) and shadow conditions of said environment ; an Image Analysis Server 150, comprising: a Composer 110 for enabling a user to compose a mixed-reality (photorealistic) image from the shot image; an Image Processing (Analyzing) unit 115 for processing the shot picture (image), estimating camera 106 parameters, such as the focal distance of the lens of said camera, viewing direction, orientation and position of the camera in a space, determining the spatial location of said marker 201, and determining the lighting conditions of the environment (scene), according to the “real” lighting conditions, determined by said marker 201; a Configuration Database/Repository 120 for storing: images and videos, users' settings, scene and objects configurations and definitions, rendered (output) images and videos; a Model and Material Database 130 for storing 3-D (dimensional) predefined models and materials, such as wood-texture, steel-texture, etc. (provided by the manufacturers) to be integrated into said shot image, or storing links to these models and materials, if they are physically stored at another location (e.g., on the manufacturer's server); and an Image Rendering unit 125 for rendering (reconstructing) the photorealistic image(s)/video(s) by integrating the virtual item into said predefined location of said environment, and simulating the “real” lighting (and corresponding shadow) conditions of said environment.

According to a preferred embodiment of the present invention, a user 105′ places a dedicated marker 201 within an environment to be photographed, takes (photographs) a picture of said environment along with said marker 201, and then uploads (sends) the picture to Image Analysis Server 150 for processing. It should be noted that the picture can be composited and/or uploaded to Image Analysis Server 150 by means of Composer software interactive application 110 that can be a Web application installed within said Server 150. Composer software interactive application 110 provides the user with a software tool for compositing a mixed-reality image, enabling said user to select the virtual object (e.g., 3-D model, textured material, etc.) he wishes to embed into the prior shot picture, and to initiate a mixed-reality-rendering process that is performed by said Image Analysis Server 150. In turn, Image Analysis Server 150 receives the image, processes and renders said image, generating the final output: an image with a preselected virtual object (e.g., 3-D model, textured material, etc.) that is relatively smoothly embedded within said image in a place wherein marker 201 is positioned (by occluding said marker 201). The output image can be provided to the same user 105′ and/or to any other user (e.g., user 105″), to which it can be sent by email, by MMS (Multimedia Messaging Service) and by any other way.

For example, it is supposed that user 105′ surfs the Web, looking for a new sofa or a piece of furniture for his apartment. Once he finds the item on a specific Web site, he considers adding it to his wish-list and clicks on a button located next to said item within the Web site. The button can be labeled, for example, “View the item in your personal environment”. Then, a new application window can pop-up with the selected item (object) loaded, explaining to the user what to do next. After that, user 105′ puts dedicated marker 201 within his apartment where he wishes to place the desired sofa later on. Then, he takes a picture of his apartment along with said marker 201, and uploads the image to Image Analysis Server 150. Next, he configures the desired object (e.g., selecting color and other features) and defines the output format of the resulting image (e.g. 320*240 pixels, VGA, XGA etc.). Finally, he enters one or more addresses of recipients (i.e., phone numbers for MMS (Multimedia Messaging Service) or e-mail addresses). On Image Analysis Server 150, the required processing is performed and the resulting image is delivered to the defined recipients, possibly including the sender himself (as a recipient). It should be noted that such activities can be performed in PC-based (Personal Computer) environments as well as on mobile devices.

It should be noted that Image Processing unit 115, provided within Image Analysis Server 150, analyses the image by determining marker 201 and estimating camera parameters, such as the focal distance of the lens of said camera, viewing direction, orientation and position of said camera, based on the marker's 2-D image representation and the known real properties: for example, the optical distortion of the camera lens (and other optical parameters) can deduct the real distance and position of marker 201. According to a preferred embodiment of the present invention, all six degrees of freedom (e.g., three coordinates for the position of said camera in a space, and three for its viewing direction and orientation) are estimated by means of Image Processing unit 115 to be further reconstructed from the photographed image by means of Image Rendering unit 125.

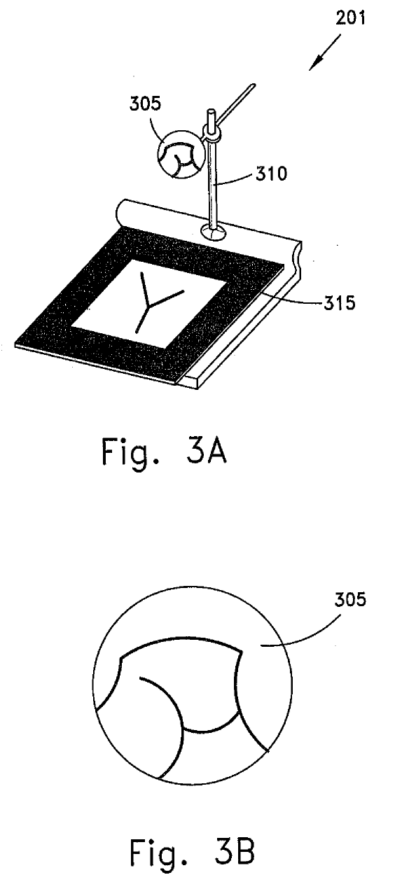

According to another preferred embodiment of the present invention, marker 201 comprises a mirror sphere that can be provided on a rod 310 (FIG. 3A) for determining the lighting (optical) conditions of the environment within which the picture is taken. Image Processing unit 115 further analyzes (evaluates) the reflections from said mirror sphere, which are used as the basis for a computer graphical calculation, titled “Inverse Environment Mapping”. According to such calculation, Image Processing unit 115 processes the picture, and by use of the conventional AR (Augmented Reality) toolkit (presented, for example, in the article “Marker Tracking and HMD Calibration for a Video-based Augmented Reality Conferencing System”, H. Kato et. al., Proceedings 2nd IEEE and ACM International Workshop, pages 85 to 94, 1999), said Image Processing unit 115 finds the pixels within said picture, which depict the reflecting sphere 305 (of marker 201). These pixels always form a circle, since said reflecting sphere 305 has a circular form, and the position of said reflecting sphere 305 is known due to the predefined position and length of rod 310 in relation to said marker 201. Then, Image Processing unit 115 extracts the circular shape of reflecting sphere 305 and maps the pixels, which are on the outside of the (small) reflecting sphere 305, to the inside of a large virtual sphere. The large virtual sphere is used as background (as a lighting source), i.e. it determines which color and intensity of the light comes from which direction. The large virtual sphere is constructed by a “reverse projection” from the small reflecting sphere 305. According to a particular preferred embodiment of the present invention, only a half of the sphere is on the shot picture, and thus only a hemisphere is calculated. The large virtual sphere is used as a source for the “real” environment based lighting, for example, creating an environment map of “real” lighting conditions. As a result, the environment map is obtained, which is an Inverse Environment Mapping 2-D image. In the computer graphics, such environment maps are usually used to determine visual properties of virtual objects in their environment(s). Then, the camera parameters (e.g., the focal distance of the lens of said camera, etc.) as well as the environment map are stored within Configuration Database/Repository 120. After that, they are forwarded to Image Rendering unit 125, together with a corresponding 3-D model/material from Model and Material Database 130, to be integrated within the image. It should be noted that the model configuration is preset by the user earlier. Image Rendering unit 125 renders said image with said 3-D model/material and generates the final composed image. For that, Image Rendering unit 125 utilizes the camera parameters previously obtained by means of Image Processing (Analyzing) unit 115 and considers the position and direction of the virtual object in the scene, according to conventional rendering techniques as they used in conventional rendering systems (e.g., picture shading or ray tracing). Thus, its makes sure that the object rendered (integrated) into the image appears at the correct position and direction within the image. Consequently, the marker is occluded by the integrated object. For improving the output visual quality, two key approaches can be used: first, movie-quality rendering engines can be used, such as Pixar's® RenderMan® or Maya® with MetalRay®; second, the environment map received with the other configuration data from Image Processing unit 115, can be utilized to apply corresponding lighting conditions to the virtual object to be integrated within the image. This enhances the visual quality and gives the impression of the virtual object being right in the scene, under the same lighting conditions as real objects within the image. For example, a virtual object, such as a chair, casts a shadow on the ground in most real scenarios (with the light coming from above). Also, other objects, next to said virtual object, are affected by its shadow. According to a preferred embodiment of the present invention, this problem is treated by adding one ore more virtual shadow planes to said virtual object: thus, the object is inserted into the image together with its shadow(s).

According to a preferred embodiment of the present invention, Image Rendering unit 125 generates a photorealistic mixed-reality image and stores it within Configuration Database/Repository 120. Then, said photorealistic mixed-reality image is delivered to the recipient (user 105″) via email and/or MMS (Multimedia Messaging Service) and, optionally, accompanied by text.

It should be noted that according to a preferred embodiments of the present inventions, the main processing is performed at the server 150 side, enabling users to use relatively lightweight and relatively cheap photographic devices (e.g., mobile phones that have relatively low processing resources, thus saving their battery power).

According to a preferred embodiment of the present invention, marker 201 is composed of a flat black-and-white board (or paper) and, optionally, a reflecting sphere with a mounting rod. When providing said reflecting sphere, current lighting conditions of the environment can be determined. The black-and-white board (or paper) can comprise a predefined texture for enabling Image Processing unit 115 to further determine its relative (spatial) position in space (horizontal, vertical, or under some angle). Marker 201 can be provided to users via email in a conventional file format, or it can be easily downloaded from a predefined Web site to be further printed. In addition, marker 201 can be provided to users in stores, restaurants, etc. in an already printed form, for free or for some predefined cost.

According to a preferred embodiment of the present invention, an Image Analysis Server 150 can be provided as more than one server, such that one or more of its units (e.g., Composer 110, Image Processing unit 115, a Configuration Database/Repository 120, a Model and Material Database 130, Image Rendering unit 125) can be located on a separate server. Further, each server can be located at different physical location.

According to a preferred embodiment of the present invention,, if a user has a mobile device (e.g., cellular phone, PDA (Personal Digital Assistant) with a screen, he can display such marker 201 on the screen and then put said mobile device in a corresponding place within the environment, wherein he wishes a virtual object to be displayed. After that, he can take a picture of said environment be means of his camera.

According to another preferred embodiment of the present invention, each image/video to be processed and to be integrated with a virtual object can be shot by means of a conventional photo/video camera or by means of a conventional mobile device (such as a cellular phone, PDA, etc.) having such camera.

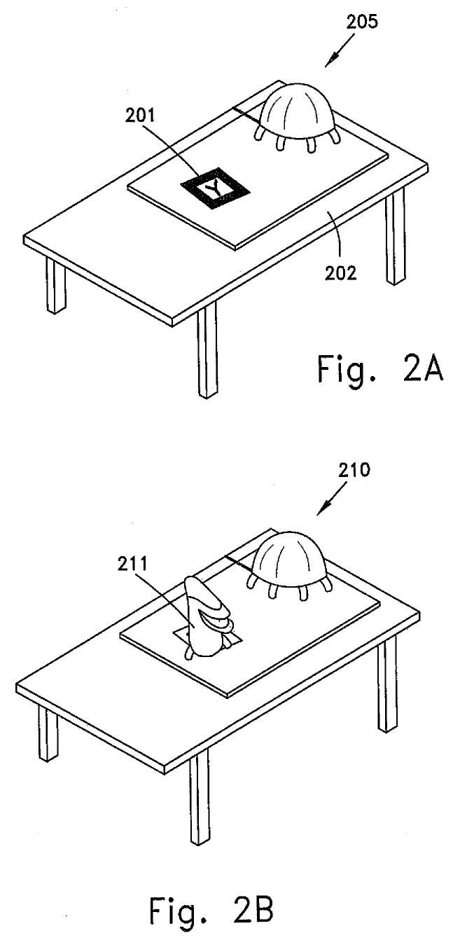

FIGS. 2A and 2B are sample input and output images 205 and 210, respectively, according to a preferred embodiment of the present invention. Marker 201 is placed on a table 202 in a specific place, wherein a virtual object should be located. Then, a user takes (shoots) a picture of table 202 with said marker 201, and uploads said picture (input image 205) to Image Analysis Server 150 (FIG. 1) for processing, by means of Composer software interactive application 110 (FIG. 1) installed within said Server 150. In turn, Image Analysis Server 150 receives the image, processes and renders said image, generating the final output: an image 210 with a preselected virtual object 211 (e.g., 3-D model, textured material, etc.) that is relatively smoothly embedded within said image in a place wherein marker 201 is positioned (by occluding said marker 201).

FIG. 3A and 3B are illustrations of dedicated marker 201 and its reflecting sphere 305, respectively, according to another preferred embodiment of the present invention. According to this preferred embodiment, marker 201 further comprises a reflecting sphere 305 with a mounting rod 310. The base 315 of marker 201 is composed of a flat, black-and-white board (or paper). Reflecting sphere 305 enables Image Analysis Server 150 (FIG. 1) to determine lighting conditions of the environment wherein the picture/video is taken. Image Processing unit 115 (FIG. 1) provided within said Server 150, analyzes the image and, according to the reflection level from said sphere 305, determines from what side a lamp or any other light source is positioned, and in turn, to what side the corresponding shadow should be projected when rendering said image by means of Image Rendering unit 125 (FIG. 1).

According to a preferred embodiment of the present invention, the “real” lighting conditions are reconstructed by the following way:
User 105′ (FIG. 1) takes a picture (or video) of the environment, in which marker 201 is placed in a predefined location.
Image Processing unit 115 processes the picture, and by use of the conventional AR (Augmented Reality) toolkit, said Image Processing unit 115 finds the pixels within said picture, which depict the reflecting sphere 305 (of marker 201). These pixels always form a circle (since said reflecting sphere 305 has a circular form).
Image Processing unit 115 extracts the circular shape of reflecting sphere 305 and maps the pixels, which are on the outside of the small reflecting sphere 305 to the inside of a large virtual sphere.

The large virtual sphere is used as background (as a lighting source), i.e. it determines which color and intensity of light comes from which direction. The large virtual sphere is constructed by a “reverse projection” from the small reflecting sphere 305.
The large virtual sphere is used as a source for the “real” environment based lighting (i.e., creating an environment map of “real” lighting conditions).
The environment map emits (virtual) light, which relatively closely resembles the real light situation of the scene. It should be noted that this is called “environment lighting”, comparable to “environment mapping” in computer graphics. Since the light sources are not part of the known scene, they need to be estimated (from the pixel map of the large virtual sphere). Then, these lighting conditions are applied to the virtual objects of the mixed reality scene. It affects only the artificial object(s), the rest of the scene (the original image) remains unchanged.
Image Rendering unit 125 generates the final (output) image, where the artificial lighting fits the “real” lighting conditions.

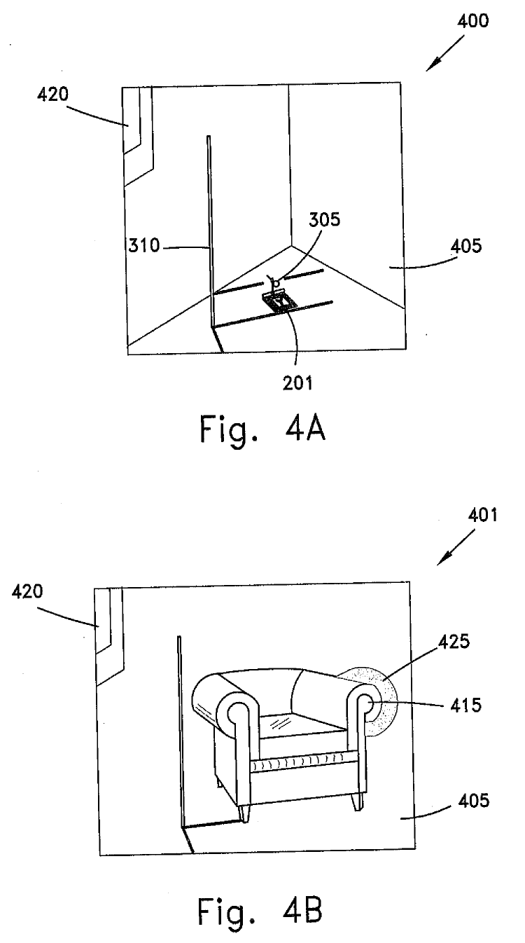

FIGS. 4A and 4B are sample input and output images 400 and 401, respectively, according to another preferred embodiment of the present invention. Marker 201, having reflecting sphere 305 with mounting rod 310, is placed on a floor 405 near the window 420, wherein a new sofa 415 should be located. A user takes (shoots) a picture of the environment with said marker 201, and uploads said picture (input image 400) to Image Analysis Server 150 (FIG. 1) for processing by means of Composer software interactive application 110 (FIG. 1) installed within said Image Analysis Server 150. In turn, Image Analysis Server 150 receives the image, processes and renders said image, generating the final output: an image 210 with a new sofa 415 that is relatively smoothly embedded within it, in a place wherein marker 201 is positioned (by occluding said marker 201). The output image 401 has the “real” lighting conditions, and sofa 415 projects its shadow 425 on the wall due to the light from window 420.

According to a preferred embodiment of the present invention, a user (such as user 105′ or 10511 (FIG. 1)) can select and configure the virtual item to be integrated into the photographed environment. For example, the item can be selected from Model and Material Database 130 (FIG. 1), or it can be selected from any other database over a data network, such as the Internet, cellular network or the like. Further, the user can select and configure the item from a Web site over the Internet. The item configurations and definitions can be stored, for example, in Configuration Database/Repository 120 (FIG. 1).

It should be noted that the photorealistic method and system 100 (FIG. 1) of the present invention can be used in a plurality of applications, such as shopping applications, architectural simulation applications, entertainment applications, and many others. Furthermore, the photorealistic method and system 100 of the present invention can be used for the industry and mass market at the same time.

While some embodiments of the invention have been described by way of illustration, it will be apparent that the invention can be put into practice with many modifications, variations and adaptations, and with the use of numerous equivalents or alternative solutions that are within the scope of persons skilled in the art, without departing from the spirit of the invention or exceeding the scope of the claims.

1. A system for providing and reconstructing a photorealistic environment, by integrating a virtual item into it, comprising:
a) a dedicated marker, placed in a predefined location within an environment, in which a virtual item has to be integrated, for enabling determining the desired location of said virtual item within said environment;
b) a conventional camera for taking a picture or shooting a video clip of said environment, in which said marker was placed, and then providing a corresponding images of said environment; and
c) one or more servers for receiving said corresponding image of said environment from said camera, processing it, and outputting a photorealistic image that contains said virtual item integrated within it, comprising:
c.1. a composer for composing a photorealistic image from said corresponding image of said environment;
c.2. an image processing unit for processing said corresponding image and for determining the location of said marker within said environment;
c.3. a configuration database for storing configurations and other data; and
c.4. an image rendering unit for reconstructing the photorealistic image by integrating said virtual item into said predefined location of the photographed environment, wherein said marker is located.

2. System according to claim 1, wherein the marker enables the image processing unit to determine a spatial location of the virtual item to be integrated into the environment.

3. System according to claim 1, wherein providing the marker enables determining lighting and corresponding shadow conditions of the photographed environment.

4. System according to claim 1, wherein the image rendering unit further simulates lighting and corresponding shadow conditions of the photographed environment.

5. System according to claim 1, wherein the marker is composed of a black-and-white board.

6. System according to claim 1, wherein the marker is composed of a board, having a predefined texture for enabling to determine a spatial orientation of said marker within the photographed environment.

7. System according to claim 1, wherein the marker comprises a mirror reflecting sphere for determining the lighting and corresponding shadow conditions of the environment, in which it is located.

8. System according to claim 7, wherein the mirror reflecting sphere of the marker is connected to said marker by means of a rod.

9. System according to claim 7, wherein the image processing unit by means of the marker mirror reflecting sphere further determines which color and/or intensity of the light, within the photographed environment, comes from which direction.

10. System according to claim 1, wherein the image processing unit is further used for estimating camera parameters.

11. System according to claim 10, wherein the camera parameters are selected from one or more of the following:
a. the focal distance of the lens of said camera;
b. the viewing direction and orientation of said camera; and
c. the position of said camera in a space.

12. System according to claim 1, further comprising providing a model and material database for storing predefined models and materials to be integrated into the taken image of the environment, or storing links to said models and materials, if they are stored on another server.

13. System according to claim 1, wherein the marker is displayed on a mobile device screen or provided in a printed form.

14. System according to claim 1, wherein a user can select and configure the virtual item to be integrated into the photographed environment.

15. A method for providing and reconstructing a photorealistic environment by integrating a virtual item into it, comprising:
a. placing a dedicated marker in a predefined location within an environment, in which a virtual item has to be integrated, for enabling determining the desired location of said virtual item within said environment;
b. taking a picture or shooting a video clip of said environment, in which said marker was placed, by means of a conventional camera; and
c. receiving said image of said environment with a maker from said camera by means of one or more servers, processing said image, and outputting a photorealistic image that contains said virtual item integrated within it, said one or more servers comprising:
c.1. a composer for enabling a user to compose a photorealistic image from said corresponding image of said environment;
c.2. an image processing unit for processing said corresponding image and for determining the location of said marker within said environment;
c.3. a configuration database for storing users' configurations and other data; and
c.4. an image rendering unit for reconstructing the photorealistic image by integrating said virtual item into said predefined location of said environment.

16. Method according to claim 15, further comprising determining by means of the image processing unit a spatial location of the virtual item to be integrated into the environment, in a place wherein the marker is located.

17. Method according to claim 15, further comprising determining the current lighting and corresponding shadow conditions of the photographed environment by means of the image processing unit, due to placing the marker within said environment.

18. Method according to claim 15, further comprising reconstructing, by means of the image rendering unit, the photorealistic image of the photographed environment by simulating its current lighting and corresponding shadow conditions.

19. Method according to claim 15, further comprising providing the marker with a predefined texture for enabling to determine its spatial orientation within the photographed environment.

20. Method according to claim 15, further comprising providing the marker with a mirror reflecting sphere for determining the lighting and corresponding shadow conditions of the environment, in which it is located.

21. Method according to claim 20, further comprising determining by means of the image processing unit, due to providing the marker mirror reflecting sphere, which color and/or intensity of the light within the photographed environment, comes from which direction.

22. Method according to claim 15, further comprising estimating camera parameters by means of the image processing unit.

23. Method according to claim 22, further comprising selecting the camera parameters from one or more of the following:
a. the focal distance of the lens of said camera;
b. the viewing direction and orientation of said camera; and
c. the position of said camera in a space.

24. Method according to claim 15, further comprising providing a model and material database for storing models and materials to be integrated into the taken image of the environment, or storing links to said models and materials, if they are physically stored on another server.

25. Method according to claim 15, further comprising displaying the marker on a mobile device screen or providing said marker in a printed form.
